(19) United States
(12) Patent Application Publication
(10) Pub. No.: US 2005/0225778 A1
(43) Pub. Date: Oct. 13, 2005

(54) Method, apparatus, system for data conversion, and computer product

(75) Inventor: Yuuji Izumi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/996,958

(22) Filed: Nov. 24, 2004

(30) Foreign Application Priority Data
Mar. 31, 2004 (JP) 2004-105081

(51) Int. Cl. G06K 1/00; B41B 1/00; H04N 1/40; H04N 7/14

(52) U.S. Cl. 358/1.1; 348/14.01; 348/14.11; 348/14.12; 348/14.13; 345/903; 345/547; 358/2.1

(57) ABSTRACT

A data transfer system can be smoothly applied in transferring data between operation system that store data. In an operation system, an operation processor accesses data of a data storage unit, whereby contents stored by the data storage unit are updated. An adaptor refers to an extraction definition table, and transmits the updated data. The transmitted information is received by a data HUB system, which refers to a dictionary and converts the data format to a reference format, selects a transfer destination operation system by referring to a definition table, refers to a dictionary corresponding to the transfer destination and converts the data, and thereafter transmits the data to the transfer destination operation system. The transfer destination operation system receives the data, and updates its own data storage unit.

### BACKGROUND OF THE INVENTION

1) Field of the Invention

The present invention relates to a technology for converting data of one computer to a format suitable for another computer.

2) Description of the Related Art

Sometimes data stored in one computer is transferred to and used on another computer.

Computer data is generally updated whenever necessary. At a transfer destination, data must be transferred constantly from the most recent transfer source in order to update data that is stored continuously in a transfer destination computer.

However, when data is transferred from source to destination whenever necessary, processing between them becomes burdensome. In particular, when there is a large amount of data, much of the computer processing time is spent in transferring the data, reducing the efficiency of the processing operations that ought to be executed.

Accordingly, data is conventionally totaled in fixed units of time, such as one day or one hour, and the data totaled at that time is transferred in a single transmission (see for example, Japanese Patent Application Laid-open No. 2002-99451).

According to the conventional technique of transferring data at predetermined time intervals, when attempting to use data generated at the transfer destination computer, use of the data is delayed by one day or one hour, or the like, making it difficult to utilize the data with a high degree of freshness. To deal with this problem and use data freshly, an application that captures an event generated by updating data, and instantly sends the data to the other computer system, must be created for each database.

To transfer data to a different computer system, the data must be converted to the format handled by the other computer system. An application program is used to process and convert the format of the data. When converting data between a plurality of computer systems, an enormous system must be constructed in order to create programs that convert and process data in each database.

In a system that includes a plurality of computer systems of this type, the connection status of the computer systems changes as their operations change. Consequently, operations to change the system, in order to accommodate changes in the connection status that follow when specific operations are added or deleted, or the like, become too complex and numerous to be practical.

### SUMMARY OF THE INVENTION

It is an object of the present invention to solve at least the problems in the conventional technology.

A data transfer apparatus according to an aspect of the present invention is connected to a plurality of operation systems via communication lines, the operation systems including a first operation system as a data sender and a second operation system as a data receiver. The data transfer apparatus includes a format storing -unit that store information in a corresponding manner on a data format used by each operation system in processing data and a reference data format; a definition table storing unit that stores definition information relating to categories and transfer destinations of data that could be received by the data transfer apparatus; a destination determining unit that, upon the data transfer apparatus receiving data from the first operation system, refers to the definition information stored in the definition table storing unit and determines the second operating system as data receiver; an format converting unit that refers to the information stored in the format storing unit and converts a data format of the data received to the reference data format, and converts the reference data format of the data to a data format that corresponds to the second operation system; and a data sending unit that sends the data having a data format that corresponds to the second operation system to the second operation system.

A method according to another aspect of the present invention is a method of converting data format of data and sending the data format converted data, the method is executed on a data transfer apparatus connected to a plurality of operation systems via communication lines, the operation systems including a first operation system as a data sender and a second operation system as a data receiver. The method including storing information in a corresponding manner on a data format used by each operation system in processing data and a reference data format; storing definition information relating to categories and transfer destinations of data that could be received by the data transfer apparatus; referring, upon the data transfer apparatus receiving data from the first operation system, to the definition information and determining the second operating system as data receiver; referring to the information on the formats and converting a data format of the data received to the reference data format, and converting the reference data format of the data to a data format that corresponds to the second operation system; and sending the data having a data format that corresponds to the second operation system to the second operation system.

A computer program according to still another aspect of the present invention realizes the above-mentioned method on a data transfer apparatus.

A computer-readable recording medium according to still another aspect of the present invention stores therein the above-mentioned computer program.

A data transfer system according to still another aspect of the present invention includes a data transfer apparatus; and a plurality of operation systems connected to the data transfer apparatus via communication lines, the operation systems including a first operation system as a data sender and a second operation system as a data receiver. The first operation system includes a data storage unit that is accessed when an application software of the operation system is executed; an extraction definition table that stores updates of the data storage unit in correspondence with extraction categories used when extracting the transfer data; and a transfer controller that refers to information stored in the extraction definition table, and extracts data from the data storage unit. The data transfer apparatus includes a format storing unit that store information in a corresponding manner on a data format used by each operation system in processing data and a reference data format; definition table storing unit that stores definition information relating to categories and transfer destinations of data that could be received by the data transfer apparatus; a destination determining unit that, upon the data transfer apparatus receiving data from the first operation system, refers to the definition information stored in the definition table storing unit and determines the second operating system as data receiver; an format converting unit that refers to the information stored in the format storing unit and converts a data format of the data received to the reference data format, and converts the reference data format of the data to a data format that corresponds to the second operation system; and a data sending unit that sends the data having a data format that corresponds to the second operation system to the second operation system. The second operation system includes a data storage unit that is accessed when an application software of the operation system is executed; and a reflection unit that reflects data, sent from the data transfer apparatus, in the data storage system.

The other objects, features, and advantages of the present invention are specifically set forth in or will become apparent from the following detailed description of the invention when read in conjunction

### with the accompanying drawings. BRIEF DESCRIPTION OF THE DRAWINGS

FIG. 1 is a schematic diagram of a data transfer system of an embodiment according to the present invention;

FIG. 2 is a function block diagram of the data transfer system shown in FIG. 1;

FIG. 3 is a flowchart of matching processing on the data transfer system shown in FIG. 1;

FIG. 4 is a flowchart of reflection processing on the data transfer system shown in FIG. 1;

FIG. 5 is a table for an information processing example of reflection processing on the data transfer system shown in FIG. 1;

FIGS. 6A and 6B are tables for an information processing example of reflection processing on the data transfer system shown in FIG. 1;

FIGS. 7A and 7B are tables for an information processing example of reflection processing on the data transfer system shown in FIG. 1;

FIG. 8 is a flowchart of transfer processing on the data transfer system shown in FIG. 1;

FIG. 9 is a flowchart of transfer processing on the data transfer system shown in FIG. 1;

FIG. 10 is a flowchart of transfer processing on the data transfer system shown in FIG. 1; and

FIG. 11 is a flowchart of transfer processing on the data transfer system shown in FIG. 1.

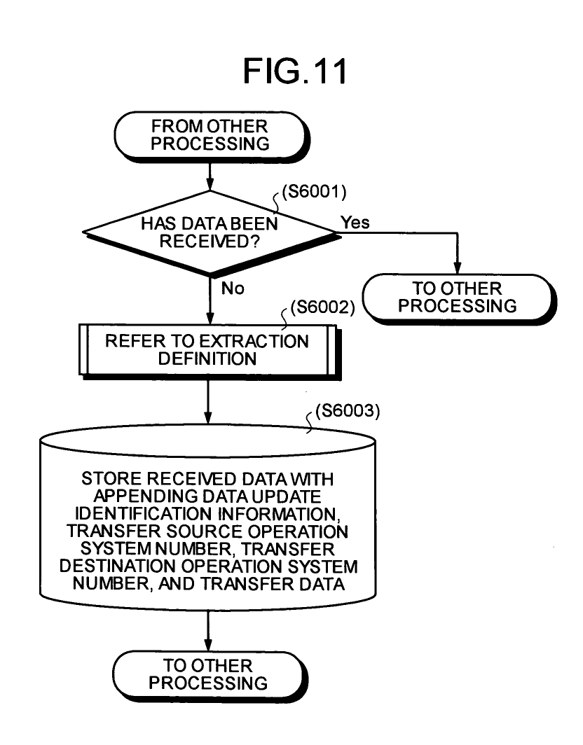

### DETAILED DESCRIPTION

Exemplary embodiments of a data conversion apparatus, a data conversion method, a data conversion system, and a computer product according to the present invention are explained below with reference to accompanying drawings.

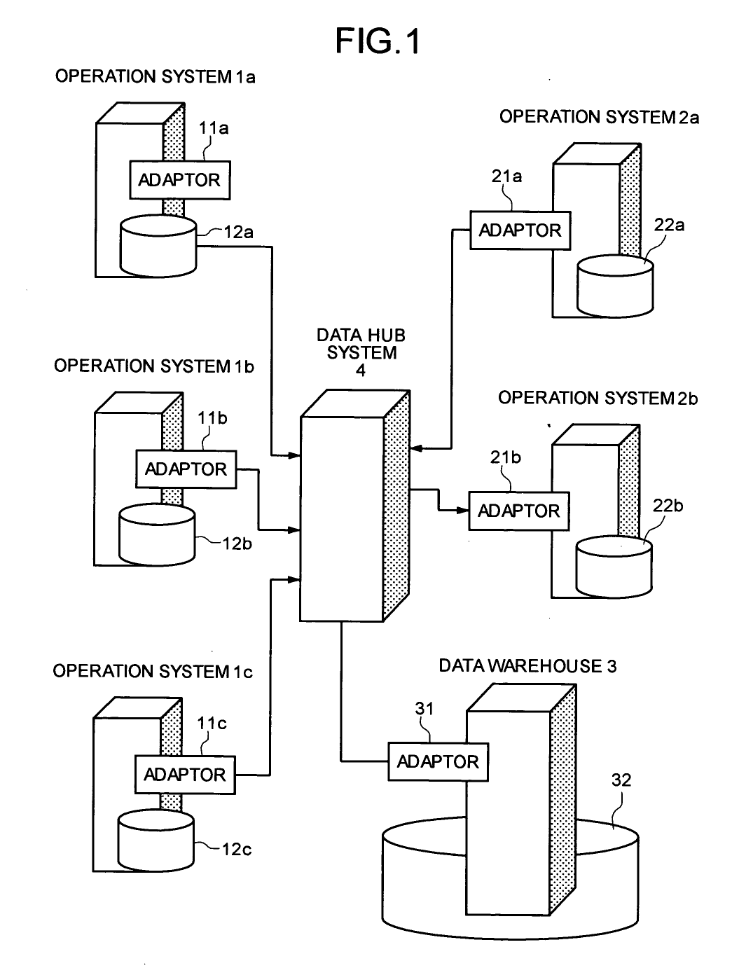

FIG. 1 is a schematic diagram of a data conversion system according to an embodiment of the present invention.

In FIG. 1, reference signs 1a, 1b, and 1c, represent operation systems at data transfer sources, which transfer stored data to other systems. The operation systems respectively include adaptors 11a, 11b, and 11c, which control transfer of data to other systems, and data storage units 12a, 12b, and 12c, where data are accessed corresponding to operation processing.

Reference signs 2a and 2b represent operation systems at data transfer destinations, which store data transferred from the operation systems 1a, 1b, and 1c, and perform operation processing based on the stored data. The operation systems 2a and 2b respectively include adaptors 21a and 21 that manage the receiving of information transferred from other operations systems, and storage units 21a and 21b that store the transferred data.

A reference sign 3 represents a data warehouse that stores and manages data. The data warehouse 3 includes an adaptor 31 that controls the receiving of data transferred from the operation systems 1a, 1b, and 1c, and a data storage unit 32 that stores the received data.

A reference sign 4 represents a data HUB system that converts data, transferred from the operation systems 1a, 1b, and 1c at the transfer source, to a format that can be used by the operation systems 2a and 2b and the data warehouse 3, and transfers the data to the operation systems 2a and 2b and the data warehouse 3.

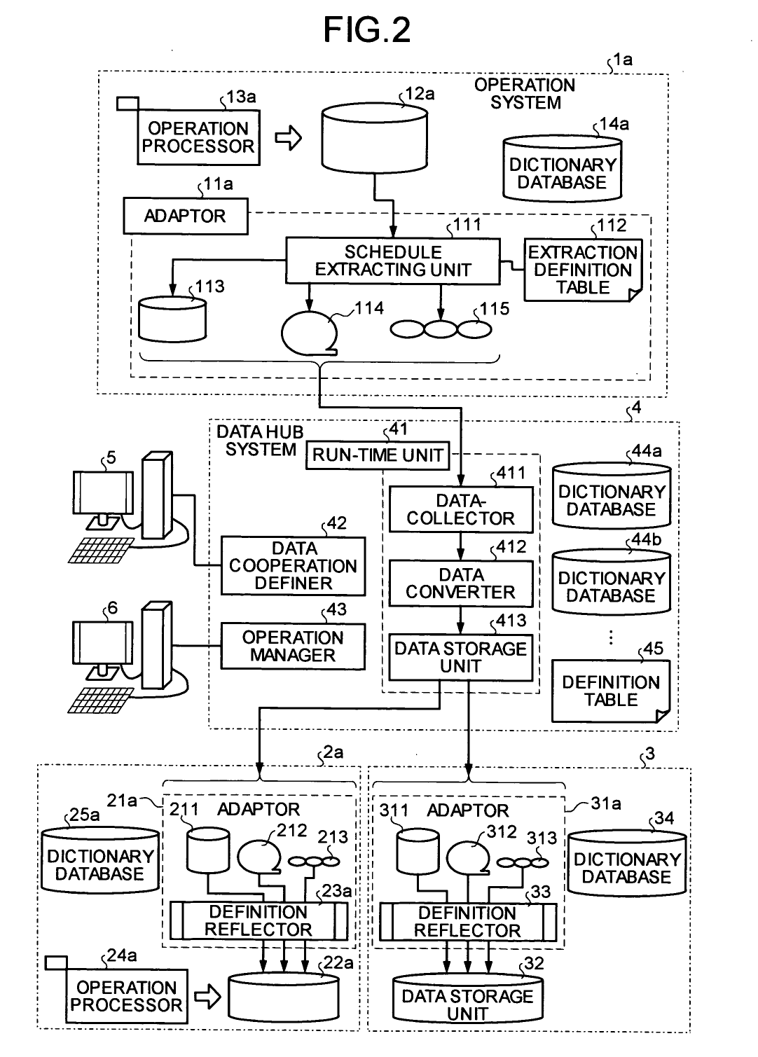

The constitutions of the operation systems 1a, 1b, and 1c will be explained in detail with reference to FIG. 2. However, since the operation systems 1a, 1b, and 1c have same or similar constitutions, only the constitution of the operation system la will be explained here with reference to FIG. 2. Moreover, since the transfer source operation systems 2a and 2b have the same constitutions, only the constitution of the operation system 2a will be explained here with reference to FIG. 2.

In the operation system 1a, the adaptor 11a includes a schedule extracting unit 111 that extracts data within a range stored in an extraction definition table 112 from the data storage unit 12a at extraction timings stored in the extraction definition table 112, and, corresponding to the range, creates an all file 113, a batch-difference file 114, and a trans-difference 115, and transmits them to the data HUB system 4. A reference sign 13a represents an operation processor that performs operation processing by accessing data in the data storage unit 12a.

A reference sign 14a represents a dictionary database that stores data formats of data stored in the data storage unit 12a, reference data formats, and a conversion dictionary.

In the operation system 2a, the adaptor 21a receives the all file 211, the batch-difference file 212, and the trans-difference 213, which are transmitted from the data HUB system 4, and a definition reflector 23a reflects all these files in the contents of the data storage unit 22a. A reference sign 24a represents an operation processor that performs operation processing by accessing data in the data storage unit 12a. A reference sign 15a represents a dictionary database that stores data formats of data stored in the data storage unit 22a, reference data formats, and a conversion dictionary.

In the data warehouse 3, the adaptor 21 receives the all file 311, the batch-difference file 312, and the trans-difference 313, which are transmitted from the data HUB system 4, and a definition reflector 33 reflects all these files in the contents of the data storage unit 32. A reference sign 34 represents an operation processor that performs operation processing by accessing data in the data storage unit 32. The reference sign 34 also represents a dictionary database that stores data formats of data stored in the data storage unit 32, reference data formats, and a conversion dictionary.

The data HUB system 4 includes a run-time unit 41 that converts files, which are sent from a transfer source operation system, to files of a format that can be used by the transfer source operation system or by the data warehouse 3, a data cooperation definer 42, which connects to a terminal 5, and stores definition information relating to data cooperation corresponding to a command from the terminal 5, and an operation manager 43 that connects to a terminal 6, and performs operation management processing of the data HUB system 4 in correspondence with an operation management sequence that is defined by the terminal 6.

The data HUB system 4 also includes a plurality of dictionary databases 44a, 44b, . . . , for converting between the data format and reference data format of data handled by the connected operation systems la to 1c, 2a, and 2b, and the data warehouse 3.

Further, the run-time unit 41 includes an data-collector 411 that collects information from transfer source operation systems such as the operation system 1a, a data converter 412 that converts data, collected by the data-collector 411, to a data format that can be used by the transfer destination operation systems and the data warehouse 3, and a data storage unit 413 that transfers data to the transfer destination operation systems and the data warehouse 3 where the data is to be stored.

Subsequently, the operation of the data transfer system will be explained.

Since there are different types of systems, systems other than the data HUB system 4 will hereinafter be collectively termed “system” in order to simplify the explanation. Therefore, the term “system” used without specific restrictions refers to all systems other than the data HUB.

Matching of the dictionary databases 44 of the data HUB system 4 and the operation systems will be explained.

As explained above, the data HUB system 4 converts data, which is sent from transfer source operation systems, to a data format that can be used by a predetermined transfer destination operation system or the data warehouse 3, and thereafter transfers the data to the system or the data warehouse 3.

To execute this processing smoothly and efficiently, the transfer source data is converted to data in a reference format, and the reference data is then converted to a data format that matches the transfer destination system, as described later. By holding a conversion dictionary database of the data formats handled by each system and the reference data formats, it becomes possible to convert and transfer the data without holding dictionaries for all data formats of the transfer sources and transfer destinations.

Accordingly, the data HUB system 4 includes dictionary databases 44a . . . for each system.

Since the dictionary database is a conversion dictionary for converting between the data format of the operation system that executes processing and a reference format, its conversion definitions should basically be managed by the manager of each system.

However, since the conversion processing itself is executed by the data HUB system 4, the conversion dictionary data of each system must be stored in the dictionary database of the data HUB system 4.

There are two conceivable methods for doing this. In the first method, dictionary data of each system is stored in the dictionary databases 44a . . . of the data HUB system 4. In the second method, each system has a separate dictionary database, and, when the manager of each system corrects an external dictionary database in the system he/she manages, he/she sends correction information to the data HUB system 4, and the corresponding dictionary database of the data HUB system 4 is updated so that the dictionary data stored therein matches that of each system.

An advantage of the first method is that storing the dictionary data in the dictionary databases avoids having to send a communication relating to the dictionary data, and consequently there is no need to consider pressure of the communications line relating to updates, or the processing load. However, there is a disadvantage that the data format cannot be changed in the corresponding system. By contrast, in the second method, although there are increases in the communication relating to updates that are appended, and the load on each system and the data HUB system 4, the manager of each system need only correct the contents of his own dictionary database, and this information is automatically reflected on the data HUB system 4 side, enabling the data format to be smoothly reflected.

Therefore, the first method is useful in a system where the data format is rarely updated, and the second method is useful in a system where the data being handled is frequently changing.

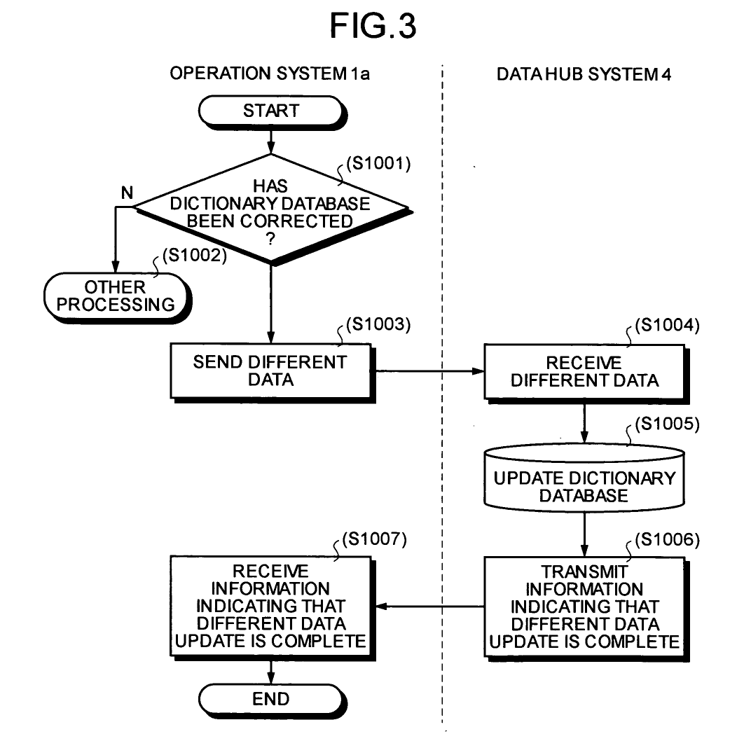

The dictionary databases 44a, 44b, . . . are managed using the second method. Processing to match each system with the dictionary database of the data HUB system 4 will be explained with reference to FIG. 3.

Since each system performs the same matching processing, this explanation describes processing for matching the data storage unit 12a of the operation system 1a with the corresponding dictionary database 44a of the data HUB system 4.

Firstly, the operation system 1a checks whether the content of the dictionary database 14a has been corrected by the manager (S1001). If not, the sequence shifts to another process (S1002).

When the content has been corrected, the difference information of the dictionary database 14a is sent to the data HUB system 4 (S1003).

The data HUB system 4 receives the information (S1004), and updates the corresponding dictionary database 44a based on the received data (S1005).

When updating processing is complete, the data HUB system 4 transmits information indicating that the different data update is complete (S1006).

The operation system 1a receives the information (S1007), and the updating processing ends.

Subsequently, a process of updating the extraction definition table of each system will be explained.

When transferring data to other systems with the data HUB system 4, which is at the core, it is necessary to store information indicating which data the data HUB system 4 transfers to which system. In addition, since the transfer source systems store the extracted data, and the extracted portion of the database of each system must be managed, the transfer source system holds an extraction definition table, and the transfer destination system includes a unit that reflects the definitions.

The data HUB system 4 includes a system that automatically reflects changes in the definition table and the like of each system, by inputting a correlation between the transfer source systems and the transfer destination systems.

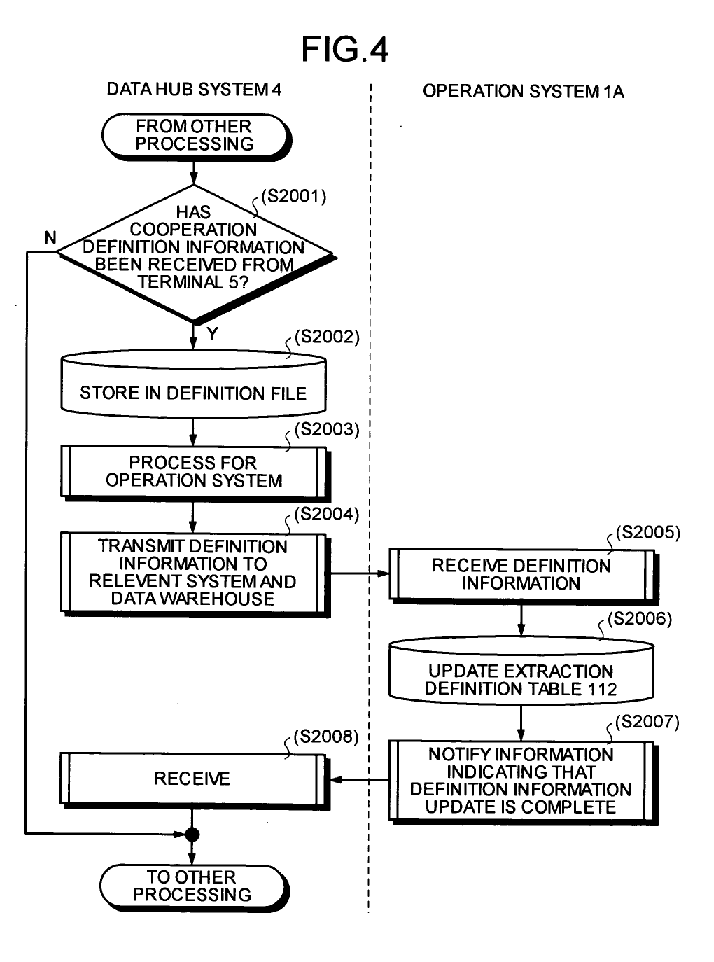

Reflection processing will be explained with reference to FIG. 4. The reflections are input to the terminal 5 by the manager of the data HUB system 4, and the input information is reflected in all the systems.

Since the reflection processing is performed in the same way as above in each system, this example describes reflection processing between the operation system 1a and the data HUB system 4.

Firstly, the data HUB system 4 checks whether cooperation definition information has been received from the terminal 5 (S2001). If not, the sequence shifts to another process. When the information has been received, it is stored in the definition table 45 (S2002).

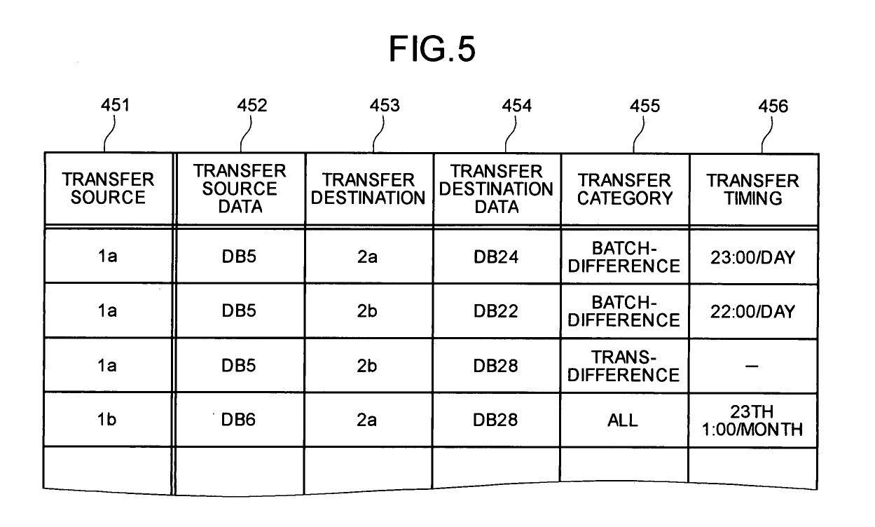

FIG. 5 is an example of information received by the terminal 5. As shown in FIG. 5, the terminal 5 receives a number of the transfer source operation system 451 (to simplify explanation, the numerals designated to the operation systems in FIG. 1 are used here), a data number in the database of the transfer source operation system 452, the number of the transfer destination operation system 453, a data name that is reflected in the transfer destination operation system 454, a transfer category (batch-difference, trans-difference, all) 455, and transfer timing information 456, and stores them in the definition table 45.

As mentioned above, there are three transfer categories 455 (batch-difference, trans-difference, and all). “Batch-difference” is the process of transferring the different data that has been updated so far in each write-good period. “Trans-difference” is the process of transferring the different data at the point where data is updated. “All” is the process of transferring all the contents of the database at a specified timing.

The definition information is analyzed, and information that relates to each operation system is processed. This is a process of gathering information that relates to each transfer source and each number of transfer destination operation system in the stored information.

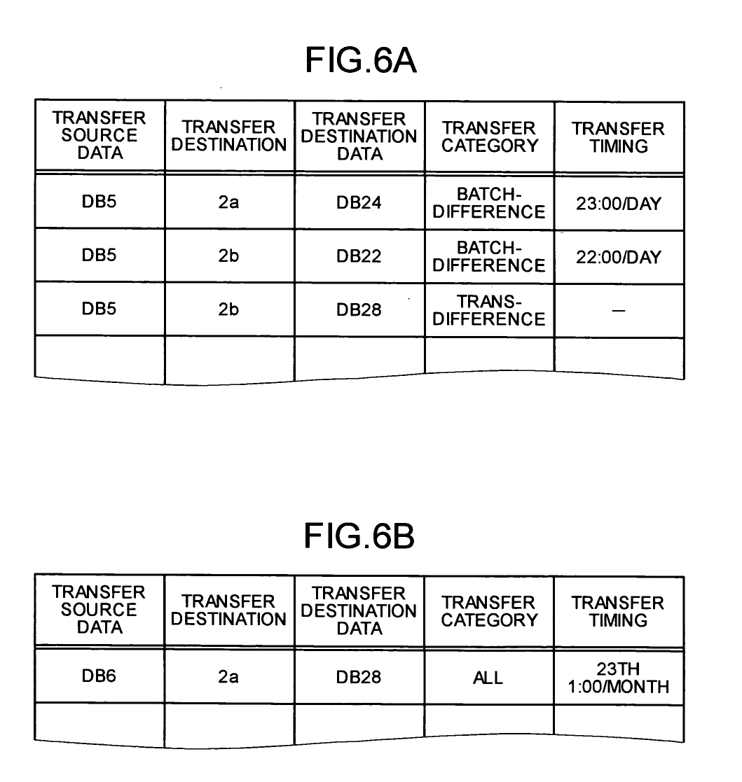

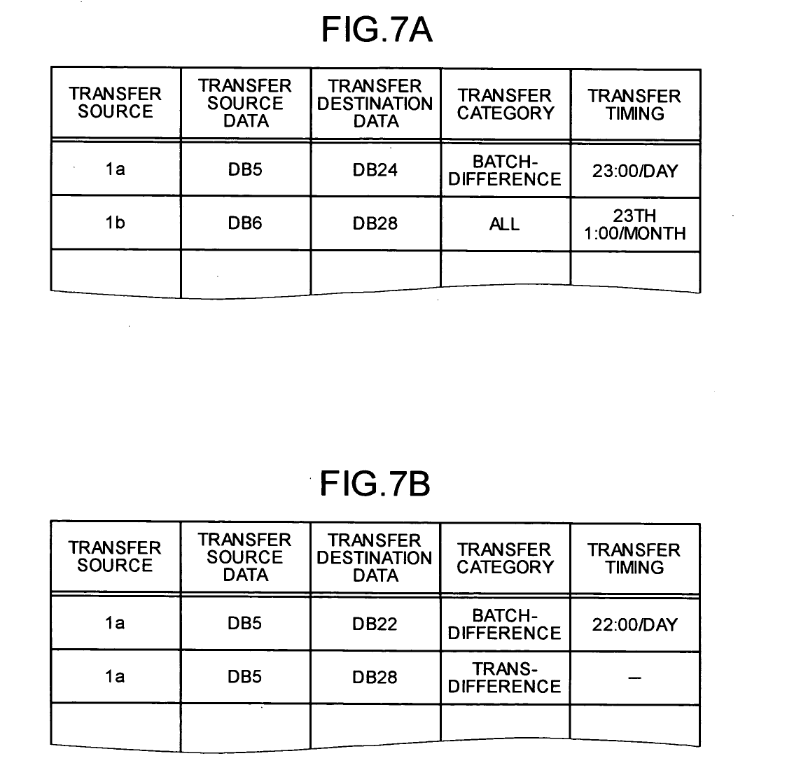

FIGS. 6A, 6B, 7A, and 7B are examples of the information of FIG. 5 that has been processed in the above manner.

FIG. 6A and 6B are examples of information that has been processed for use by a transfer source operation system, data 457 being definition data for the operation system 1a. As shown in FIG. 6A and 6B, only data that relates to the transfer source operation system number 451 of “1a” (representing the operation system 1a) is extracted from the data of FIG. 5.

Definition data extracted by the same process is shown as data 458 for the operation system 1b.

FIG. 7A and 6B are examples of information that has been processed for use by a transfer destination operation system. Data 459 is definition data for the operation system 2a, and data 460 is definition data for the operation system 2b.

The data HUB system 4 sends the operation data, processed in this manner, to the relevant operation systems (S2004). The operation system 1a receives the definition data for the operation system 1a (S2005), and updates the extraction definition table 112 based on the definition data (S2006).

When updating processing is complete, the operation system la notifies the data HUB system 4 of this fact (S2007).

When the data HUB system 4 receives notification that the updating processing is complete from all the operation systems (S2008), it completes external processing and shifts to another processing.

Transfer of data from one operation system to another, while dictionary data is being matched and definition-reflected in the manner described above, will be explained.

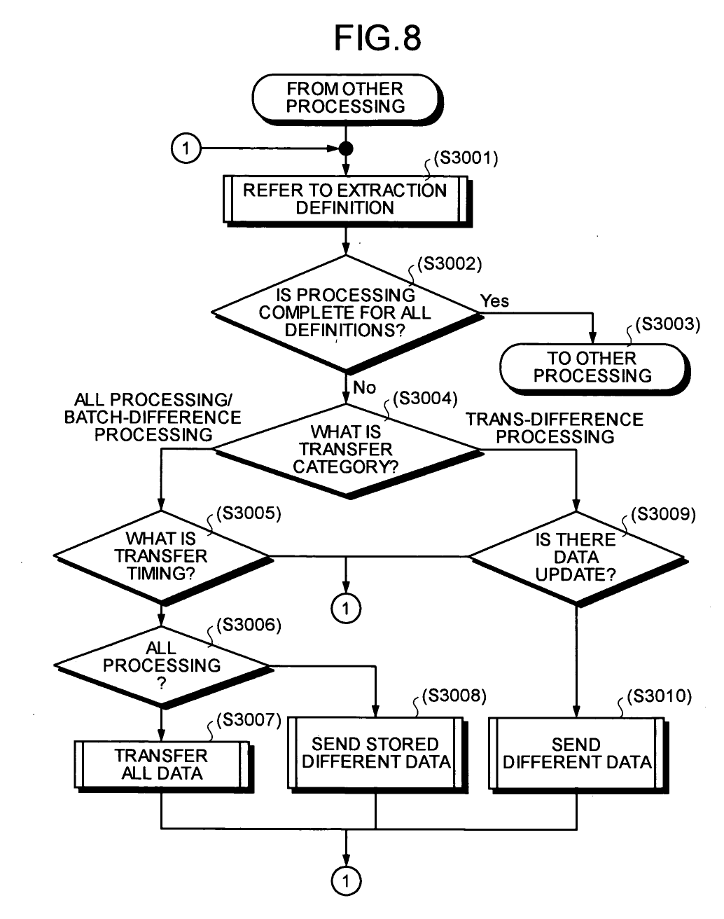

Firstly, data transfer processing at the transfer source operation system 1a will be explained with reference to the flowchart of FIG. 8. Since the same data transfer processing is executed in the transfer source operation systems 1a and 1b, this example describes only the processing in the operation system 1a. Of course, the operation system 1b performs the same processing. Unless otherwise stated, this processing is performed by the schedule extracting unit 111 in the adaptor 11a of the operation system.

At the operation system 1a, a plurality of processes are executed. When shifting from another process to the data transfer process, the operation system 1a refers to the extraction definition table 112 (S3001), and confirms whether transfer processing is complete for all entries in the extraction definition table 112 (S3002).

When transfer processing is complete for all the defined entries, the sequence shifts to another process (S3003).

When not complete, the schedule extracting unit 111 extracts one entry that has not been transfer-processed, and checks its transfer category (S3004). When its category is all or batch-difference, the transfer timing of the same item is checked (S3005). When it is determined that it is not an update timing, processing shifts to S3001, where the next item is processed. When the timing is determined to be an update timing, it is determined whether the transfer category is all (S3006), and if so, all of the data 113 are sent to the data HUB system 4 (S3007).

When the category is batch-difference, difference information 114 relating to data that is updated from the previous transfer processing until now is transmitted to the data HUB system 4 (S3008). When the processing of S3008 or S3009 is complete, the sequence shifts to S3001.

When it is determined in S3004 that the transfer category is trans-difference, it is determined whether data is updated at that point (S3009). If so, the different data 115 resulting from the update is sent to the data HUB system 4 (S3009), and the processing sequence shifts to S3001.

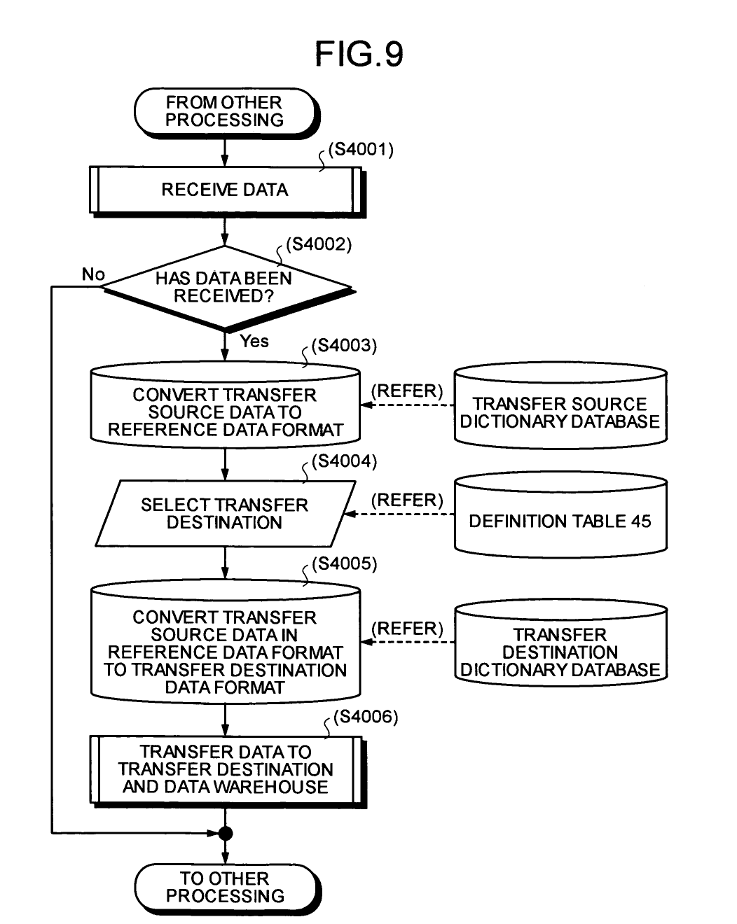

Processing whereby the data HUB system 4 transfers information, sent from the transfer source system in this way, to the transfer destination, will be explained with reference to the flowchart of FIG. 9.

Unless otherwise stated, this processing is executed by the run-time unit 41 of the data HUB system 4.

Firstly, the data is received (S4001), and the run-time unit 41 confirms whether the data has been sent from the transfer source operation system 1a or 1b (S4002). When no data is sent, this process ends, and shifts to another process. When data is received, the run-time unit 41 refers to the dictionary database for the transfer source operation system, and converts the data format from the transfer source operation system to reference data. For example, if the data is from the operation system 1a, the corresponding dictionary database 44a is referred to and the data format is converted to the reference data format (S4003).

The run-time unit 41 then refers to the definition table 45, and selects a transfer destination for the data.

For example, when transfer data DB5 is sent from the transfer source operation system 1a, the run-time unit 41 refers to the definition table 45 of FIG. 5, and selects a transfer destination from the data and its timing (S4004). For example, when the transfer source data DB5 is sent at 23:00, its transfer destination is the operation system 2a. While it is explained above that the transfer destination is identified from the timing and data name, it is permissible to store identification numbers for each entry of the definition data in the definition table 45 so that the transfer destination can be decided by referring to the definition table 45 based on the identification number.

The run-time unit 41 refers to the dictionary database that corresponds to the transfer destination operation system selected in this way, and converts data, which is converted to the reference format in S2003, to a data format of the transfer destination. In addition, the data is converted to a data format of the data warehouse 3 (S4005).

The converted data are transferred to their respective transfer destinations and to the data warehouse 3 (S4006), whereby processing ends.

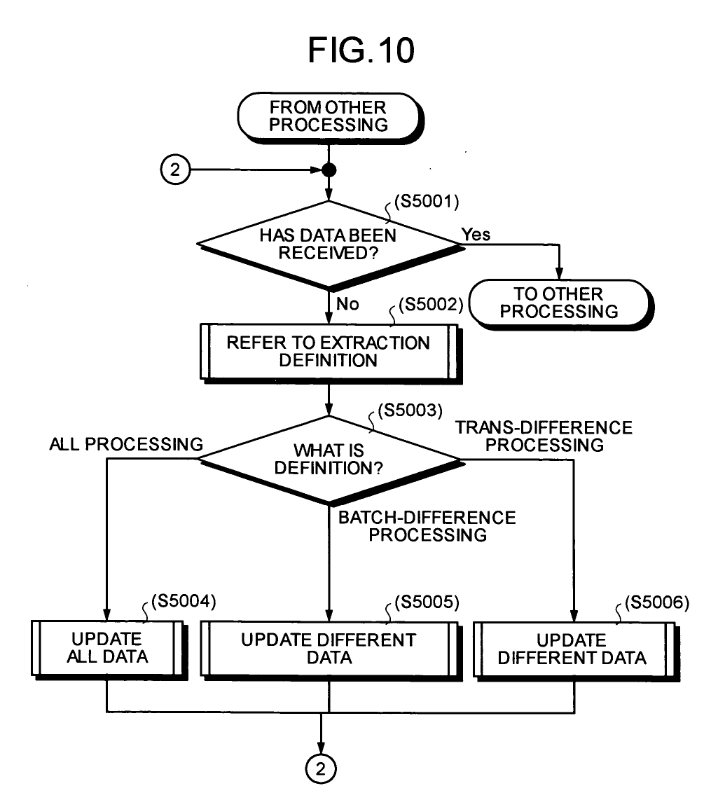

Processing to reflect the data that is sent from the data HUB system 4 in the transfer destination operation system will be explained based on the flowchart of FIG. 10.

Since the same processing is performed by the transfer destination operation systems 2a and 2b, only that of the operation system 2a will be explained here.

This processing is executed by the definition reflector 23a in the adaptor 21a of the operation system 2a, and, unless otherwise stated, the definition reflector 23a executes the processing in the following explanation. The definition reflector 23a has a definition table (not shown), sent from the data HUB system 4 shown in FIG. 7A and 7B.

The definition reflector 23a receives the data (S5001), refers to the definition table (S5002), and determines how to process the received data (S5003).

At this time, when the sent data is determined to be all the data, all the corresponding data in the database is replaced by the sent data (S5004). When the sent data is determined to be batch-difference data or trans-difference data, the difference information is reflected in the present data (S5005 and S5006).

For example, when the data is identified as data DB5 of the operation system 1a, the transfer category is batch-difference information. The operation system 2a can determine that this is to be reflected in data DB24, and performs processing to do so.

Processing at the data warehouse 3 will be explained.

The data warehouse 3 stores transferred data as occasion arises, and is used in other processing such as analyzing difficulties in the system.

As described in FIG. 9, all the transfer data are sent to the data warehouse 3, and the data warehouse 3 stores the sent information.

Data storage processing in the data warehouse 3 will be explained below.

This processing is performed by the definition reflector 33 of the data warehouse 3, and, unless otherwise stated, the definition reflector 33 performs this processing in the following explanation.

When it receives the data (S6001), the definition reflector 33 refers to its definition table (S6002), and stores the received data with appending data update identification information, a transfer source operation system number, a transfer destination operation system number, and transfer data (S6003).

In this way, all the update information in the system is stored in the data storage unit 32.

This configuration enables data to be transferred reliably in real time, even between operation systems having different data formats.

The adaptors in the operation systems and the data HUB system 4 do not need to include hardware, but may, for example, include software forming an application level base, such as middleware. Such middleware enables data to be transferred automatically, with no need for large-scale additions to the application software that is used directly by the users.

The present invention converts the data format of data from the operation systems to a reference data format, or vice versa.

Specifically, a “product code” that is used in the operation system is, for example, converted to a referential name such as a “product name”. Alternatively, the “product name” is converted to a “product code” at the corresponding transfer destination. Only a person who actually uses the operation system knows the standard for this type of conversion. Therefore, according to reference format conversion in this embodiment, the person in charge of the operation system corrects the dictionary for his own operation system, and the corrections are automatically reflected in the dictionary database that correspond to the operation system of the data HUB system 4.

In addition, although the reference data in the above explanation is “product name”, it is acceptable to set a reference product code that corresponds to the product, and convert the “product code” of the operation system to the reference “product code”, or vice versa.

At the time of conversion, there is a correlative relationship between “stock information” and “order information”, in that the stock decreases when an order is placed. During conversion, it is possible to automatically calculate this difference prior to transfer.

In transferring data between the transfer source operation system and the data HUB system 4, when transferring all data or batch-difference data, the data is transmitted in file units. To ensure that the files are reliably stored in the data supply HUB, a generation management mechanism is provided for the files that are transmitted to the data supplier, and a unit for dealing with retransmission requests from the data HUB system 4 is provided, thereby enabling the data to be transferred more reliably.

In a data transfer by trans-difference data, when transmitting data sequentially to the data HUB system 4, loss of data is prevented by a transaction recovery function that uses a database management system (DBMS) of the support source operation system.

When data is transferred from a supply source operation system, it is impossible to recreate operations in the system on the data supply side by looking at only one database, as with form data. In such a case, there may be a plurality of product orders in one operation, or products may be listed according to their product codes. Data in this state cannot be handled by another computer system.

Accordingly, the transfer source adaptor is equipped with a continuous file/dictionary file and a slip-format conversion unit, and can deal with data in such formats by appending information to generated data, and by supplying slip-format data to the data HUB unit.

In this embodiment, the operation manager 43 communicates with the terminal 6.

The operation manager 43 supplies the present flow of data transfer in the data HUB system 4 to the terminal 6.

The operation manager 43 enables the manager of the data HUB system 4 to ascertain the transfer status in the data HUB system 4, and easily detect problems (such as bottleneck problem) in the transfer processing of the data HUB system 4.

According to the present invention, data generated in a specific computer system is supplied to a data HUB in real time using the data generation event as a trigger. The data is processed and edited into a format handled by the destination computer based on the supplied data, and instantly transmitted to the destination computer system. This enables data to be supplied with a high degree of freshness from the computer system where it is generated to a computer system that will use it. By realizing this mechanism using middleware, it is possible to provide a system mechanism that can transfer data in real time between a plurality of computer systems, without creating an application program, inexpensively and in a short space of time.

Since the data is transferred by using the data transfer apparatus as a relay in what is termed a hub and spoke format, in a multi-sever system including a plurality of computer systems, necessary operation computers can be added, and unnecessary operation computers can be deleted, without affecting the other computer systems, making it possible to construct a computer system that can smoothly accommodate operation changes.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A data transfer apparatus connected to a plurality of operation systems via communication lines, the operation systems including a first operation system as a data sender and a second operation system as a data receiver, comprising:
a format storing unit that store information in a corresponding manner on a data format used by each operation system in processing data and a reference data format;
a definition table storing unit that stores definition information relating to categories and transfer destinations of data that could be received by the data transfer apparatus;
a destination determining unit that, upon the data transfer apparatus receiving data from the first operation system, refers to the definition information stored in the definition table storing unit and determines the second operating system as data receiver;
an format converting unit that refers to the information stored in the format storing unit and converts a data format of the data received to the reference data format, and converts the reference data format of the data to a data format that corresponds to the second operation system; and
a data sending unit that sends the data having a data format that corresponds to the second operation system to the second operation system.

2. The data transfer apparatus according to claim 1, further comprising a definition update notification unit that sends a notification to all or some of the operation systems when the definition information in the definition table storing unit is updated.

3. The data transfer apparatus according to claim 1, further comprising a format updating unit that updates information on the data format upon receiving information on a new format from an operation system from among the operation systems.

4. A method of converting data format of data and sending the data format converted data, the method is executed on a data transfer apparatus connected to a plurality of operation systems via communication lines, the operation systems including a first operation system as a data sender and a second operation system as a data receiver, comprising:
storing information in a corresponding manner on a data format used by each operation system in processing data and a reference data format;
storing definition information relating to categories and transfer destinations of data that could be received by the data transfer apparatus;
referring, upon the data transfer apparatus receiving data from the first operation system, to the definition information and determining the second operating system as data receiver;
refering to the information on the formats and converting a data format of the data received to the reference data format, and converting the reference data format of the data to a data format that corresponds to the second operation system; and
sending the data having a data format that corresponds to the second operation system to the second operation system.

5. The method according to claim 4, further comprising sending a notification to all or some of the operation systems when the definition information is updated.

6. The method according to claim 4, further comprising updating information on the data format upon receiving information on a new format from an operation system from among the operation systems.

7. A computer program that realizes a method of converting data format of data and sending the data format converted data on a data transfer apparatus, the data transfer apparatus being connected to a plurality of operation systems via communication lines, the operation systems including a first operation system as a data sender and a second operation system as a data receiver, comprising:
storing information in a corresponding manner on a data format used by each operation system in processing data and a reference data format;
storing definition information relating to categories and transfer destinations of data that could be received by the data transfer apparatus;
referring, upon the data transfer apparatus receiving data from the first operation system, to the definition information and determining the second operating system as data receiver;
refering to the information on the formats and converting a data format of the data received to the reference data format, and converting the reference data format of the data to a data format that corresponds to the second operation system; and
sending the data having a data format that corresponds to the second operation system to the second operation system.

8. A data transfer system comprising
a data transfer apparatus; and
a plurality of operation systems connected to the data transfer apparatus via communication lines, the operation systems including a first operation system as a data sender and a second operation system as a data receiver,
the first operation system including
a data storage unit that is accessed when an application software of the operation system is executed;
an extraction definition table that stores updates of the data storage unit in correspondence with extraction categories used when extracting the transfer data; and
a transfer controller that refers to information stored in the extraction definition table, and extracts data from the data storage unit;
the data transfer apparatus including
a format storing unit that store information in a corresponding manner on a data format used by each operation system in processing data and a reference data format;
a definition table storing unit that stores definition information relating to categories and transfer destinations of data that could be received by the data transfer apparatus;
a destination determining unit that, upon the data transfer apparatus receiving data from the first operation system, refers to the definition information stored in the definition table storing unit and determines the second operating system as data receiver;
an format converting unit that refers to the information stored in the format storing unit and converts a data format of the data received to the reference data format, and converts the reference data format of the data to a data format that corresponds to the second operation system; and
a data sending unit that sends the data having a data format that corresponds to the second operation system to the second operation system; and
the second operation system including
a data storage unit that is accessed when an application software of the operation system is executed; and
a reflection unit that reflects data, sent from the data transfer apparatus, in the data storage system.

9. A computer-readable recording medium that stores therein a computer program that realizes a method of converting data format of data and sending the data format converted data on a data transfer apparatus, the data transfer apparatus being connected to a plurality of operation systems via communication lines, the operation systems including a first operation system as a data sender and a second operation system as a data receiver, comprising:
storing information in a corresponding manner on a data format used by each operation system in processing data and a reference data format;
storing definition information relating to categories and transfer destinations of data that could be received by the data transfer apparatus;
referring, upon the data transfer apparatus receiving data from the first operation system, to the definition information and determining the second operating system as data receiver;
refering to the information on the formats and converting a data format of the data received to the reference data format, and converting the reference data format of the data to a data format that corresponds to the second operation system; and
sending the data having a data format that corresponds to the second operation system to the second operation system.
